(19) United States
(12) Patent Application Publication
(10) Pub. No.: US 2009/0004468 A1
(43) Pub. Date: Jan. 1, 2009

(54) PRIMER FOR COMPOSITE BUILDING MATERIALS

(76) Inventors: Yongjun Chen, Alta Loma, CA (US); Caidian Luo, Alta Loma, CA (US)

Correspondence Address: GARDERE / RJW;GARDERE WYNNE SEWELL, LLP, 1601 ELM STREET, SUITE 3000, DALLAS, TX, 75201, US

(21) Appl. No.: 12/163,452

(22) Filed: Jun. 27, 2008

Related U.S. Application Data
(60) Provisional application No. 60/937,491, filed on Jun. 28, 2007.

(51) Int. Cl. B32B 33/00; C08K 5/3412; C08K 3/22; C08K 3/34; C08K 3/26

(52) U.S. Cl. 428/351; 523/122; 524/1; 524/88; 524/431; 524/445; 524/425; 524/451; 524/456

(57) ABSTRACT

An improved primer formulation for composite building materials, such as materials that are generally cementitious, gypsum, or of another inorganic building material, such as those containing cellulose, glass, steel or polymeric fibers. The improved formulation effectively blocks moisture from penetrating the composite building material and is better than alternate or conventional primers. The formulation also improves adhesion and prevents peel failure of a topcoat when applied to the composite building material. The improved formulation acts as a weather-guard and a hydrophobic treatment to all surfaces of the composite building material upon application.

### BACKGROUND

This invention relates generally to primers, and in particular, to improved primers for building materials.

Primers, particularly those for building materials must be engineered to integrate with the building material itself and endure conditions subjected to the building material. Typical conditions that negatively impact many building materials are temperature changes, water absorption, soluble salt ingress, efflorescence, and stacking, to name a few. Unfortunately, most primers when applied to a composite building material, including those comprising a cementitious substrate, do not effectively reduce water absorption, salt accumulation, and effloresce and do not allow the building material to endure stacking. It is difficult to find a primer that can protect against all such conditions; no commercial primer is capable of such enhanced performance nor is any capable of integrating well with composite materials.

### SUMMARY

As described herein is a primer with improved properties for composite building materials, such as a cementitious material, gypsum, or other inorganic composite material. The improvements include resistance to water ingress, soluble salt ingress, weather, efflorescence and stacking damage. Consequently, a paint or topcoat applied to the primer will exhibit improved service life. The described primer is capable of maintaining durable contact between the substrate: the sealer and any exterior coating (e.g., paint).

The improved formulation effectively blocks moisture from penetrating the composite building material and is better than commercial primers. The formulation also improves adhesion and prevents peel failure of a topcoat when applied to the composite building material. The improved formulation acts as a weather-guard and a hydrophobic treatment to all surfaces of the composite building material upon application.

Some embodiments provide a primer suitable for use on a fiber cement substrate. The primer offers superior blocking resistance and wet adhesion. In addition, the primer exhibits salt resistance in a freeze-thaw environment for superior protection of a composite building material.

A primer formulation described herein comprises resins that include one or more polymers or copolymers of an acrylic, styrenated acrylic, acrylic polyurethane, acrylic epoxy, epoxy ester, polyester, alkyd, amino resin or any combination blend. The polymers or copolymers may be thermoplastic or thermosetting systems. The primer formulation further comprises up to 60% water, up to 1% of one or more dispersants, up to 0.5% of one or more wetting agents, up to 1% of one or more biocides, up to 1% of one or more antiblocking agents, up to 0.5% of one or more thickeners, up to 1% of one or more pH adjusters, up to 50% of one or more resins, up to 30% of one or more pigments, up to 70% of one or more extenders or fillers and up to 1% of one or more functional pigments. In some embodiments, the resin is an acrylate polymer. The acrylate polymer may be latex. The one or more dispersant may be a hydrophobic copolymer polyelectrolyte. The one or more wetting agents may be an acrylic wetting agent. The one or more biocides may be an industrial alginate. The one or more thickeners may be a non-ionic urethane. The one or more pigments may be titanium dioxide or iron oxide or phthalocyanine blue or combinations thereof. The one or more extenders may be calcium carbonate, talc, calcined clay, calcium silicate and/or combinations thereof.

In some embodiments a primer comprises a polymer wherein the polymer has a glass transition temperature (Tg) of about 50° to 70° C. and a minimum film formation temperature of about or below 30° C.

Some embodiments further provide a primer that comprises at least one hard polymer and at least one soft polymer wherein the hard polymer has a Tg of about 30° C. or less and the soft polymer has a Tg of about 50° C. or greater.

Still further embodiments provide a primer that comprises one or more polymers where in the polymer particle size distribution is bimodal. The bimodal particle size distribution may have a first peak at or below 100 nanometers and a second peak at or greater than 200 nanometers.

Those skilled in the art will further appreciate the above-noted features and advantages of the invention together with other important aspects thereof upon reading the detailed description that follows and in conjunction with the drawings

### BRIEF DESCRIPTION OF THE DRAWINGS

For more complete understanding of the features and advantages of the inventions described herein, reference is now made to a description of the invention along with accompanying figures, wherein:

FIG. 1 is a representative photograph of cross-sections of impregnated building material samples after wet picking of a formulation described herein as compared with a commercially available primer, wherein the photograph shows two wet pickings as marked by the left two rectangular-shaped regions;

FIG. 2 is a representative photograph of cross-sections of impregnated building material samples after stacking comparing stacking resistance of a formulation described herein as compared with a commercially available primer;

FIGS. 3A-C are representative photographs of fiber cement specimen after 40 cycles of salt freeze-thaw, wherein FIGS. 3A-3B are specimens coated with an alternative conventional primer and FIG. 3C is a specimen coated with a representative primer formulation described herein; and

FIG. 4 depicts efflorescence of specimens coated with a sealer and paint formulation described herein, wherein FIGS. 4A-4B are specimens coated with representative primer formulations described herein and FIG. 4C is a specimen coated with an alternative conventional primer.

### DETAILED DESCRIPTION

Although making and using various embodiments are discussed in detail below, it should be appreciated that the description provides many inventive concepts that may be embodied in a wide variety of contexts. The specific aspects and embodiments discussed herein are merely illustrative of ways to make and use the invention, and do not limit the scope of the invention.

References will now be made to the drawings wherein like numerals refer to like or similar parts throughout. The drawing figures are not necessarily to scale and certain features may be shown exaggerated in scale or in somewhat generalized or schematic form in the interest of clarity and conciseness.

As further described herein, wet adhesion was evaluated using a modified ASTM D3359, which differed in that samples did not receive an X cut and cross cut. The adhesive was a 1 inch wide adhesive of 3M® Scotch® tape No. 250 applied directly to a coated surface (e.g., primed and/or painted) after the surface (typically the entire sample) was soaked in tap water for about 24 hours. The top surface of the tape was rolled with a 10 lb. rubber roller at for 10 cycles to promote adhesion. Tape was then removed at a 90 degree angle.

Freeze-thaw assessment was in accordance with ISO-DP8336 Standard Test Method with some modification to sample preparation. Water absorption was modified from ASTM D570 Standard Test Methods for Water Absorption of Plastics. Efflorescence evaluation relied on a modified ASTM C67.07 Standard Test Methods for Sampling and Testing Brick and Clay Structural Tile. For QUV assessment, ASTM G53 was used as a source for assessment.

Few primers integrate well with composite building materials. For example, there are only a few primers that are prepared for integration with cementitious substrates. Commercial primers, however, do not achieve a balanced performance between blocking and wet adhesion. As depicted in TABLE 1, different conventional primers (C-1, C-2 C-3). are poor at either blocking or wet adhesion when applied to a composite building material. Based on such data, these primers could not be used in production to coat a surface of a composite building material, such as a cementitious product. Such conventional primers were compared with a formulation described herein (DC-001) also applied to the same type of composite building material. DC-001 was found to be more effective than the conventional primers at both blocking and wet adhesion. Blocking, as referred to herein, describes a non-sticking performance of the coating after building materials are coated with a primer are stacked one on top of another.

TABLE 1
Blocking and wet adhesion of primers.

| | Blocking Resistance | Wet Adhesion |
|---|---|---|
| C-1 | 2(5)1 | 5% |
| C-2 | 2(5)1 | 90% |
| C-3 | 1(1) | 70% |
| DC-001 | 1(2) | 0.5% |

With TABLE 1, specimens used were sample boards of fiber cement material with the following dimension: 3 foot×8¼ inch×¼ inch. To each specimen, a textured surface was applied to one surface (face) of each specimen. Surfaces were then sealed, applied with a primer and then cured. Specimens were contacted in a face-to-face (texture-to-texture) configuration after surface temperatures of the specimens reached a temperature of about 125° F. Values in parenthesis are associated with picking damage, as described further below.

For blocking, a modified ASTM D2793 was used in which specimens were stacked and pressed at about 70 pounds per square inch (psi) at 125° Fahrenheit for about 5 minutes. A pressure of 70 psi is similar to a typical weight of about 10 pallets of composite building materials stacked together. The elevated temperature is representative of a surface temperature that such a material may reach when stacked. When blocking, a value of 1 (e.g., TABLE 1, before parenthesis) indicates boards are easily separated (no blocking). A value of 2 indicates some type of blocking (boards stick to each other and do note easily separate). The number in parenthesis represents the surface damage as a percentage. For TABLE 1, the letter code after the parenthesis indicates the force required to separate specimens: s for minor force; m for moderate force; 1 for large force.

For wet adhesion, specimens were prepared as described for blocking with the same layers: a sealer followed by a primer. After application of a sealer and primer, two coats of the same topcoat were applied for all specimens. Application of each layer (sealer, primer, topcoat1, topcoat2) was followed by drying at an elevated temperature (baking) after which specimens were allowed to dry, cool and set for one to three days. Subsequently, specimens were soaked for 24 hours in tap water. Each specimen was weighed before and after soaking in water. Paper towels were used to remove the water from the surface of each sample after soaking. 3M® Scotch® tape No. 250 was then applied to a surface of the specimen, rolled with a 10 pound roller and then removed quickly.

Referring back to TABLE 1, the table shows that 70% of a conventional primer (C-3) had peeled off with removal of tape (wet adhesion evaluation) while the primer did not experience blocking problems. On the other hand, another conventional primer (C-1) did exhibit a blocking problem, although the primer adhered relatively well after removal of tape when evaluated for wet adhesion. Neither C-1 nor C-3 would be adequate primers for a composite building material such as a cementitious substrate. Certainly C-2, which was very poor at both blocking and wet adhesion, would not be a suitable primer for a composite substrate, such as a cementitious material. The data for C-1, C-2 and C-3 are compared with that for DC-001, which generally shows no loss of paint with wet adhesion evaluation and no blocking problems. TABLE 1 proves that a formulation described herein achieves a desired balance between blocking and wet adhesion.

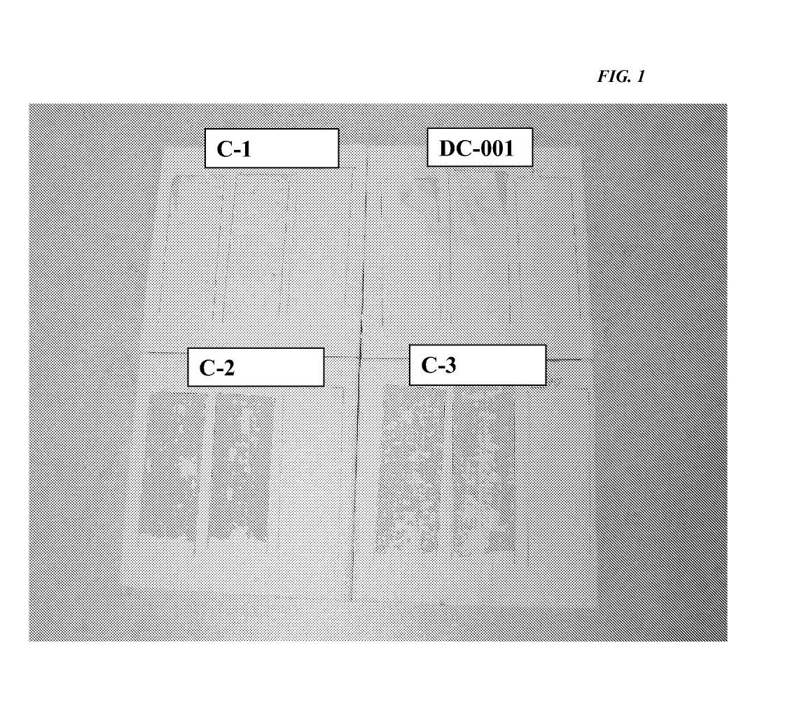

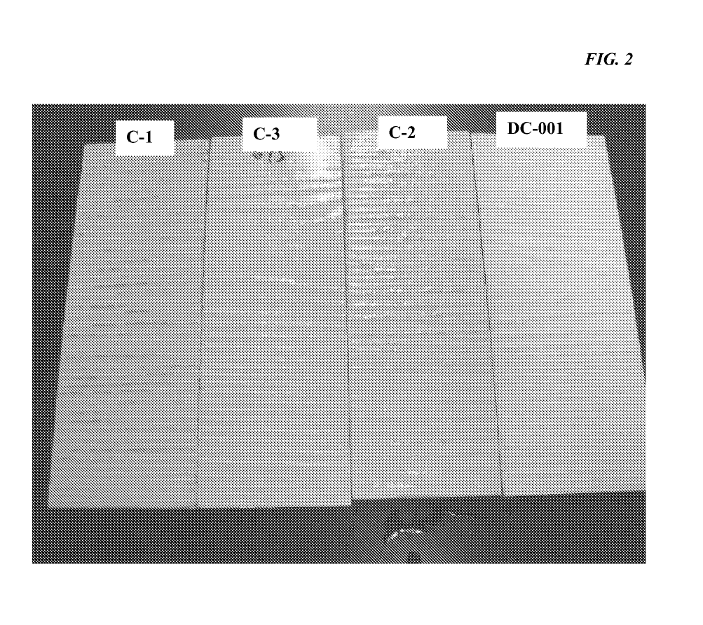

Representative examples of several specimens after wet adhesion or blocking resistance are depicted in FIG. 1 and FIG. 2, respectively. As shown in the figures, only the primer formulation described herein, represented by DC-001, exhibited both good wet adhesion (FIG. 1) and resistance to blocking (FIG. 2).

Each specimen as used herein is a representative building material, which is typically a porous material comprising one or more different materials such as a gypsum composite, cement composite, geopolymer composite or other composites having an inorganic binder. The surface of the material may be sanded, machined, extruded, molded or otherwise formed into any desired shape by various processes known in the art. The building material may be fully cured, partially cured or in the uncured “green” state. The building material may further include gypsum boards, fiber cement boards, fiber cement boards reinforced by a mesh or continuous fibers, gypsum boards reinforced by short fibers, a mesh or continuous fibers, inorganic bonded wood and fiber composite materials, geopolymer bonded wood and fiber boards, concrete roofing tile material, and fiber-plastic composite materials. Preferred fibers include various forms of cellulose fibers, such as treated or untreated, bleached or unbleached Kraft pulp. Other forms of fibers may be used. Suitable examples are those from ceramic, glass, mineral wool, steel, and synthetic polymers (e.g., polyamides, polyester, polypropylene, polymethylpentene, polyacrylonitrile, polyacrylamide, viscose, nylon, PVC, PVA, rayon, glass ceramic, carbon, any mixtures thereof).

Any additional additive may be optionally incorporated into a composite material including but not limited to density modifiers, dispersing agents, silica fume, geothermal silica, fire retardant, viscosity modifiers, thickeners, pigments, colorants, dispersants, foaming agents, flocculating agents, water-proofing agents, organic density modifiers, aluminum powder, kaolin, alumina trihydrate, mica, metakaolin, calcium carbonate, wollastonite, polymeric resin emulsions, hydrophobic agents, and mixtures thereof.

To determine water resistance of primers described herein, water absorption was evaluated by coating building material specimens on all sides with one coat of primer. A representative example of water absorption analyses is shown in TABLE 2 comparing conventional primers (C-2, C-3, C-4) with a primer formulation described herein (DC-001). Building material specimens were fiber cement substrates cut to a size of approximately 4 feet×4 inches×¼ inch. All primers were directly applied to a surface of each specimen with a defined dry film thickness (DFT) in process line. Subsequently, specimens were soaked for up to 24 hours (hrs) in tap water. Each specimens was weighed before and after soaking in water. Paper towels were used to remove the water from the surface of each sample after soaking. Water absorption was calculated as [(weight after soaking−weight before soaking)/(weight before soaking)]×100. Overall, representative primer, DC-001, showed very good water resistance performance as compared with alternative conventional primers (C-2, C-3, C-4).

TABLE 2
Water absorption in tap water.

| | Water absorption (wt. %) | | | | |
|---|---|---|---|---|---|
| | 0 hrs | 2 hrs | 4 hrs | 8 hrs | 24 hrs |
| C-2 | 0 | 20.83 | 25.81 | 28.35 | 28.37 |
| C-3 | 0 | 20.56 | 24.68 | 27.28 | 27.33 |
| C-4 | 0 | 14.60 | 20.71 | 26.26 | 28.29 |
| DC-001 | 0 | 3.65 | 6.44 | 11.28 | 26.29 |

A similar procedure as described for tap water absorption was followed for salt water absorption. The solution used was 3.5 wt. % sodium chloride in distilled water. Only a single coat of primer was applied to each specimen. TABLE 3 illustrates the salt water absorption of a representative primer formulation (DC-001) as compared with conventional primers, C-2, C-3 and C-4 in a 3.5% salt water solution. After eight hours of soaking, specimens coated with a conventional primer had salt water absorption of around 27% while DC-001 had less than 18% salt water absorption. Thus, DC-001 significantly blocked salt water from entering the specimens.

TABLE 3
Absorption of salt water.

wt. %

| | 2 hrs | 4 hrs | 8 hrs | 24 hrs |
|---|---|---|---|---|
| C-2 | 21.45 | 26.37 | 28.90 | 29.10 |
| C-3 | 20.39 | 24.13 | 26.98 | 27.69 |
| C-4 | 17.2 | 23.9 | 27.68 | 29.03 |
| DC-001 | 4.86 | 9.07 | 17.51 | 28.51 |

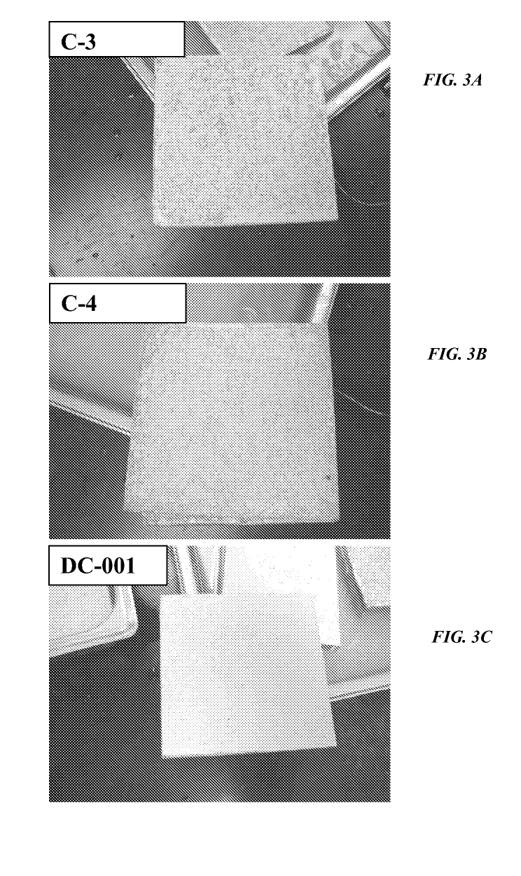

Primer formulation DC-001 was further examined in salt-freeze thaw cycles against conventional primer samples, C-3 and C-4. The freeze-thaw test used temperatures of −20 degrees Centigrade to +20 degrees Centigrade. Specimen of fiber cement were coated with a single layer of one of the primers with no additional coating. Specimens were then exposed to 40 salt freeze-thaw cycles. FIG. 3 shows representative specimens after 40 salt freeze-thaw cycles. There was damage and loss of primer on the surface of specimens coating with C-3 or C-4 primers; on the other hand, primer DC-001 remained in good condition.

QUV weathering was performed in an accelerated weathering chamber equipped with QUV-SE ultraviolet (UV)-B bulbs allowing a flexible mix of UV light, temperature and moisture conditions. The chamber is used to accelerate damage caused by sunlight, rain, and condensed surface moisture or dew. Primed specimens were subjected to alternating cycles of light and moisture at controlled elevated temperatures. The selected conditions were continued for up to 1000 hours. Each sample was coated with one of the primers identified in TABLE 4.

One important goal of coatings for building materials is sunlight durability, which is commonly measured by evaluating change in gloss and color relative to the amount of sunlight striking the surface. QUV weathering using UVB bulbs is one such measurement for sunlight durability because it accelerates sun exposure. Changes in gloss of a surface after QUV weathering indicate either polymer film or pigment breakdown or both. Likewise, pigment change and polymer breakdown are represented by a change (Δ) in light to dark (L) and yellow to blue (b), respectively.

To compare weather resistance of conventional primers and representative formulations described herein, C-4 (conventional primer) and DC-001 and DC-002 (representative primer formulations) were exposed to QUV weathering for up to 1000 hours. Primers were coated directly onto raw fiber cement boards. TABLE 4 shows data for ΔL and Δb. Color shifts after 1000 hours were observed with C-4, while little changes occurred with DC-001 and DC-002.

TABLE 4
QUV.

| QUV time | Color data | C-4 | DC-001 | DC-002 |
|---|---|---|---|---|
| 141 hrs | ΔL | 0.18 | 0.21 | 0.1 |
| | Δb | 0.24 | −0.03 | −0.09 |
| 409 hrs | ΔL | 0.13 | 0.26 | 0.09 |
| | Δb | 0.91 | −0.03 | −0.08 |
| 1003 hrs | ΔL | 1.24 | 0.25 | 0.27 |
| | Δb | −0.66 | −0.07 | −0.23 |

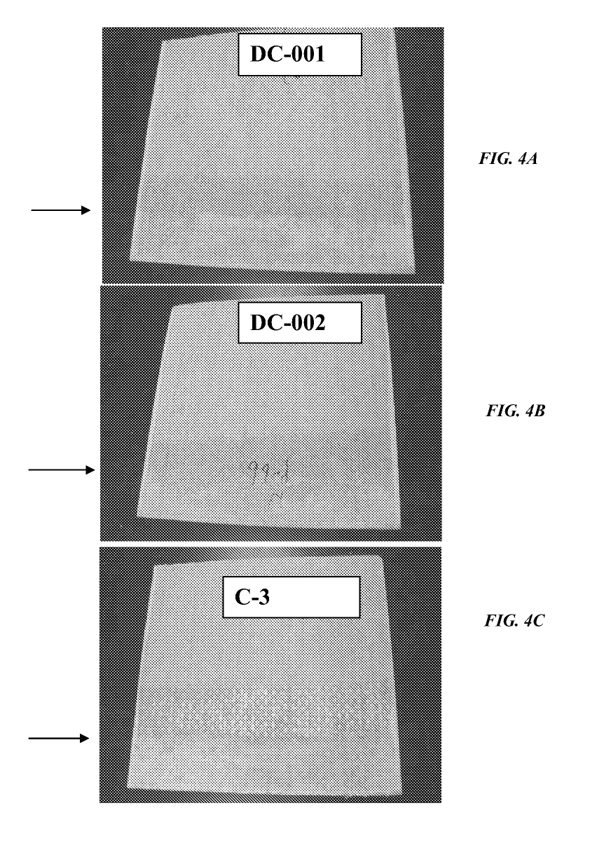

To examine salt penetration of primer film, efflorescence evaluation was carried out for various primers. Here, fiber cement specimens were coated on four sides with sealer and primer, leaving two edges (top and bottom) uncoated. After setting, each specimen was partially submerged in a sodium sulfate solution for 24 hours. FIG. 4 shows that back side of specimens. In FIG. 4, there is no white precipitate visible above the point where the sample was submerged (arrow) for specimens primed with DC-001 and DC-002. On the other hand, conventional primer (C-4) showed a large amount of white precipitate indicating sodium sulfate above the water mark further indicating migration of salt through the substrate and primer film, which was visible on the primer film surface, known as efflorescence.

A formulation for a primer as described herein has one or more of the components further described, which includes, generally, a binder, pigment, one or more extenders and one or more additives. To obtain balanced blocking resistance and wet adhesion as well as other performance features, formulations described herein have been optimized by selecting appropriate polymers as binder as well as pigments, extenders and additives. Furthermore, primer pigment volume concentration (PVC) was optimized to promote the balance between blocking resistance and wet adhesion.

Resins used herein as the binder may be thermoplastic or thermosetting systems. Representative thermoplastic and thermosetting binders include acrylic polymers, polyurethane dispersions, epoxy emulsions, amino resin polymers, alkyds, polyesters, and other water-based polymer emulsions, dispersions, copolymers (including combinations thereof). The Tg of the resin may be from 10° C. to 90° C., from 20° C. to 80° C. or from 50° C. to 71° C. The polymer emulsion/dispersion may include some volatile organic components (VOC); however, when desirable, the VOC will be zero. The percentage of polymers used depends on primer PVC, which will be discussed below.

To further improve water resistance and salt water resistance as well as blocking resistance, some hydrophobic polymers may be blended with the polymers described above. The blend dosage may be from 0 to 30% or from 0.5 to 20 wt %. These hydrophobic polymers include siloxane, silane, fluoropolymer emulsion/dispersion, polyolefin dispersion, as examples. Other hydrophobic polymers known to one of skill in the art may also be used.

When polymer emulsions or latexes are used, the minimum film formation (MFT) of the polymer emulsions may be from 0° C. to 90° C., from 10° C. to 80° C., or from 10° C. to 71° C. It is desirable that polymers have a higher Tg and yet lower MFT. The larger differences between Tg and MFT will improve film formation and blocking resistance. Examples of such polymers includes acrylic emulsions from DSM NeoResins (e.g., NeoCryl® A6069; a registered trademark of DSM NeoResins, Suisweg, The Netherlands) that has a stated Tg of 56° C. and MFT at 26° C. Such emulsions or latexes may be core-shell latexes or gradient emulsions or latexes. For core-shell latexes or gradient latexes or emulsions, the component may have two Tgs with one higher and one lower. The higher one provides hardness of a final film and the lower one assist with film formation. To achieve an appropriate balance, emulsions or latexes described herein have hard core and soft shell.

When a polymer has a Tg below 50° C., certain polymers, including siloxane wax emulsion/dispersion and fluoropolymer dispersion may added to improve non-blocking or scratch resistant performance. Consideration is made to select polymers that do not lead to interface adhesion problems. The amount added will vary depending on actual Tg of the polymer used, with a balance between Tg and PVC to achieve good performance. For example, a polymer with high Tg may be selected if the primer PVC is formulated to be lower.

To further achieve good film formation and yet a hard surface, the resin polymer may be a blend of hard polymers and soft polymers. The hard polymer provides non-blocking improvement, while a soft polymer provides good film formation. Either the hard polymers or soft polymers may be very hydrophobic in order to achieve good water resistance. In such instances, a preferred hydrophobic polymer is a soft polymer. The ratio of hard polymers to soft polymer may be optimized by further evaluating good film formation after the drying process.

To assist film formation, plasticizers may be added. Suitable plasticizers are known in the art (e.g., general or functional). Examples of general plasticizers include dibutyl phthalate (DBP) and butyl benzyl phthalate (BBP). The amounts of a general plasticizer may be from 0 to 20 wt. % based on total solids content. Examples of functional plasticizers include alkyd dispersion/emulsion and reactive diluents. The type of alkyd dispersion/emulsion will often depend on curing conditions. Generally, a short oil alkyd has a short drying time and develops film hardness quite fast. Examples of short oil alkyds include ones from Cook Composites and Polymers (e.g., Chempol® 821-1391, Chempol® 821-2241, Chempol® 821-1674, Chempol® 824-2080; registered trademarks of Cook Composites and Polymers, Kansas City, Mo.). Reactive diluents that have low volatility, excellent thinning properties and resin compatible, may be added to further assist film formation without effecting VOC. Reactive diluents may be added into the formulation before or after drying. Examples of reactive diluents include, but are not limited to di-2,7 octadienyl esters of fumaric acid or maleic acid and 2-(2,7-octadienoxy) succinic acid.

Particle size for the polymer emulsion or latex will often include both large and small sized particles. For a single polymer emulsion or dispersion, particle size distribution may be wide (e.g., a high solid emulsion or latex may have a bimodal distribution). In addition, a large particle size emulsion or dispersion may be mixed with a small particle size emulsion or latex. The combination of both large particle size and small particle size will improve film packing and formation during drying, which will improve film integrity and will also improve high PVC loading.

While adhesion of a primer formulation described herein may be improved by applying a chemical to the surface of the substrate before adding the primer (e.g., (pretreating the substrate to improve primer adhesion), it is also, in some embodiments, desirable to add one or more reactive chemicals into the primer formulation just before application. Such reactive chemicals include silane, polyaziridine, carbodimide, water dispersible isocyanate, water dispersible epoxy, melamine, zirconium salt, and other crosslinkers.

Hardness of a primer with non-blocking performance as disclosed herein may be improved with use of an encapsulated emulsion or latex. Inert pigments or fillers, including TiO₂ and clay may also be used as a core to be encapsulated by the polymer. Some encapsulated anticorrosive pigments may further improve salt water resistance.

PVC of a primer formulation disclosed herein may be between about 10% and 80%. In several embodiments, PVC is between about 20% and 70% or between about 30% and 70%. Typically, PVC will depend on pigments and extenders/fillers chosen, in addition to oil absorption and glass transition temperature of the selected polymer(s).

Pigments as disclosed herein may include organic or inorganic pigments. Examples of inorganic pigments include but are not limited titanium dioxide, iron oxide, zinc oxide. Pigments may be used in combination. The pigments selected should improve mechanical properties of the primer and may be anticorrosive. Examples of anticorrosive pigments include but are not limited to zinc phosphate, zinc polyphosphate, modified orthophosphates, and other phosphate related compounds. Organic pigments may include phthalocyanine blue, phthalocyanine green, Diarylide yellow, alkali blue, Toluidine red, as suitable examples. Some organic pigments act as corrosion inhibitors. Organic corrosion inhibitors may also improve salt water resistance. Examples include polymeric amine salt, amino carboxylate and organic acid amine (e.g., Halox® 520, 515 or 510; registered trademarks of the Hammond Group or its division, Hammond, Ind.). Pigments that improve both water resistance and blocking include zinc stearate, calcium stearate, and other stearate-related compounds. Such pigments further improve film formation and are added at a dosage of about 5 wt. % of total weight of the pigment/filler.

Functional pigments/polymers may be used to improve water and salt water resistance. Functional pigments/polymers include ion exchange resins and ion scavengers. Ion exchange resins are generally crosslinked polystyrene with functional groups and chelating resins. The functional groups may be strongly acidic, such as sulfonic acid, or strongly basic, such as trimethylammonium. Weakly acidic (e.g., carboxylic acid) or weakly basic (e.g., amino group) functional groups may also be used. A functional pigment/polymer includes calcium phosphosilicate (e.g., Halox® 430; registered trademarks of the Hammond Group or its division, Hammond, Ind.) and zeolite. When used, functional additives are generally in a dosage of about 10 wt. % of the total weight of pigment/filler.

Suitable primer extenders/fillers include calcium carbonate, talc, silica, clay, calcined clay, wallostonite, mica, feldspar, calcium silicate, barium sulfate, zinc oxide and any combination thereof. In one or more embodiments, a filler includes calcium carbonate, calcined clay, feldspar and talc. The percentage of total pigments and extenders used in formulations described herein is from about 50 to about 95% of the total weight or from about 60 to about 80%.

Additives that are used include, but are not limited to, one or more surfactants, dispersion agents, defoamers, leveling agents, biocides, pH adjusters, thickeners, antiblocking agents, coalescent agents, potassium silicate solution. The additive(s) used will depend on performance requirements of the formulation. Examples of surfactant/wetting agents include polyether modified dimethylpolysiloxane (an example of which is Byk® 348, a registered trademark of Byk-Cera, Germany), benzyl ether, octyl phenoxy polyethoxy ethanol, octylphenol ethoxylate, sulfosuccinate (e.g., Triton™ CF-10, Triton™ X-10, Triton™ X-114, Triton™ GR-5M; trademarks of The Dow Chemical Company, Midland, Mich.) and nonionic surfactants (e.g., Surfynol™ 104DPM and Surfynol™ 104E, trademarks of Air Products and Chemicals, Inc., Lehigh Valley, Pa.). A hydrophilic lipophilic balance (HLB) nonionic surfactant may be added to improve shelf-life/stability, oven aging, or resistance to freeze-thaw cycling (e.g., ethoxylate of octyl phenol, such as Triton™ X-405, a trademark of The Dow Chemical Company, Midland, Mich.).

Suitable dispersion agents may be organic or inorganic ones, including but not limited to polyacid, hydrophobic copolymer polyelectrolyte (e.g., Tamol™ 1254, Tamol™ 165A and Tamol™ 681, trademarks of Rohm & Haas Company, Philadelphia, Pa.), block copolymer with pigment affinic groups (e.g., Disperbyk® 190, a registered trademark of Byk-Chemie, GmbH, Germany) and phosphates. Suitable defoamers may be silicon based (e.g., Byk® 024, Byk® 019, Byk® 346, registered trademarks of Byk-Cera, Germany) and/or mineral oil based (e.g., Drewplus® L108, Drewplus® Y250, registered trademarks of Ashland Inc., Covington, Ky.)

With some formulations, biocides as preservatives, mildewcides, and/or algicides may be included, such as families of dioxabicyclo octane (Nuosept® 95, a registered trademark of ISP Investment Inc., Wilington, Del.), azoniaadamantane chloride (Dowicil® 75, trademark of The Dow Chemical Company, Midland, Mich.), 2-methyl-4-isothiazolin-3-one (Kathon™ LX1.5, a trademark of Rohm & Haas Company, Philadelphia, Pa.). 1,2-Benzisothiazolin-3-one (Proxel™ GXL, a trademark of Arch UK Biocides Limited West Yorkshire, Uk). pH adjusters may be ammonium water solution, ethanol amine, trimine and ethylene diamine.

Thickeners may include conventional polymers (e.g., cellulose ether), associative polymers (hydrophobically modified ethylene oxide urethane, hydrophobically modified alkali soluble emulsion and hydrophobically modified hydroxyl ethyl cellulose), thixotropes (attapulgite and bentonite caly) and metal chelates.

To moderate an effect of temperature on viscosity, some other soft and swellable polymers may be added. The soft polymer will generally increase viscosity at high temperature and decrease viscosity at low temperature.

To improve blocking resistance of primers described herein, one or more antiblocking agents may be added, such as natural and synthetic wax dispersions, silicon (e.g., MS-2 from Troy Inc.) and fluoropolymer related oligomer or polymer (e.g., FS610 from Dupont). Aqueous solutions of ammonium may be used to adjust pH of the formulation. Other bases, including ethanolamine may be added to stabilize primer pH. In some embodiments, an emulsion latex with less carboxyl groups may be used as the primary binder to reduce the pH sensitivity of the formulation.

In certain embodiments, coalescent agents are incorporated into a formulation for better film formation. Examples include ethylene glycol monobutyl ether, diethylene glycol monobutyl ether, ethylene glycol 2-ethylhexyl ether and 2,2,4-trimethyl-1,3-pentanediol monoisobutyrate. A desirable coalescent agent includes a reactive coalescent agent that stays inside the film and reacts with the polymer binders in the formulation. An example includes a propylene glycol monoester of corn oil fatty acids (e.g., Archer RC™, a trademark of Archer-Daniels-Midland Company Corporation, Decatur Ill.).

In one or more embodiments, a typical primer formulation includes up to 60% water, up to 1% dispersant, up to 0.5% wetting agent, up to 1% biocide, up to 1% antiblocking agent, up to 0.5% thickener, up to 1% ammonia water solution, up to 50% resins, up to 30% pigments, up to 70% extender, and up to 1% functional pigment. TABLE 5 shows components a typical primer formulation and acceptable ranges of the components.

TABLE 5

| | | Acceptable range | Additional range |
|---|---|---|---|
| Component | Example(s) | (wt. %) | (wt. %) |
| water | | 20 to 60 | 30 to 50 |
| dispersant | sodium salt of naphthalene- | 0.2 to 1 | 0.3 to 0.6 |
| | formaldehyde condensate | | |
| wetting agent | acrylic wetting agent | 0.1 to 0.5 | 0.1 to 0.3 |
| biocide | industrial alginate | 0.1 to 1 | 0.2 to 0.5 |
| antiblocking agent | siloxane oligomer | 0.1 to 5 | 0.1 to 1 |
| thickener | non-ionic urethane | 0.05 to 0.5 | 0.05 to 0.2 |
| pH adjuster | NH₃H₂O | 0.1 to 1 | 0.1 to 0.5 |
| binder | latex/acrylic | 5 to 80 | 10 to 50 |
| pigment | TiO₂, Fe₂O₃ | 5 to 30 | 5 to 20 |
| extender | calcium carbonate, talc, | 15 to 70 | 20 to 55 |
| | calcined clay, calcium | | |
| | silicate | | |
| functional pigment | zinc stearate | 0.1 to 1 | 0.2 to 2 |

In several preferred embodiments, suitable examples of components for a formulation include a dispersant such as Tamol™ 165, a wetting agent such as BYK® 348, a biocide such as Nuosept® 95, an antiblocking agent such as MS-2, a thickener such as 2020 NPR, a binder such as NeoCar® 820 or NeoCar® 850 (trademarks of Union Carbide Chemicals & Plastics Technology Corporation, Midland, Mich.).

The following examples provide greater detail of useful primer formulations for composite building materials, in which “part” means “part by weight” unless otherwise mentioned. The examples are not to be construed as limiting the scope of the invention described.

For preparation of a primer formulation, two processes are included: pigment paste grinding and letdown. In the pigment paste grinding process, water, pigments, fillers, additives and optionally, additional polymers were mixed together and ground by Cowles dissolver until the particle size was about 20 to about 60 micrometers (in diameter). In a second process, pigment paste, polymers, water and any other additives were blended together to form a final formulation. Blocking, wet adhesion and salt water absorption were then assessed after application of the final formulation to a substrate, as described elsewhere.

Examples of representative pigment paste recipes are shown in TABLE 7. Letdown receipt varied with PVC used.

TABLE 6

| | Example | Example | Example | |
|---|---|---|---|---|
| | #1 | #2 | #3 | Example #4 |
| Water | 40 | | | |
| Dispersant | 0.84 | | | |
| Wetting agent | 0.28 | | | |
| Biocide | 0.84 | | | |
| Defoamer | 0.18 | | | |
| TiO₂ | 15 | 15 | 15 | 15 |
| SiO₂ | 15 | | | |
| CaSiO₃ | 30 | | | |
| CaCO₃ | 20 | 50 | 48.3 | 21.3 |
| Talc | 15 | 15 | 10 | 10 |
| Calcined clay | 5 | 20 | 25 | 20 |
| Fe₂O₃ yellow | 0.5 | 0.5 | 0.5 | 0.5 |
| Fe₂O₃ black | 1.0 | 1.0 | 1.0 | 1.0 |
| Phthalocyanine blue | 0.05 | 0.05 | 0.05 | 0.05 |
| Zinc stearate | | | 1.7 | 1.7 |
| Anticorrosive pigment | | | | 12 |
| ZMP | | | | 20 |

Suitable examples of select components for the above paste formulations include a dispersant such as Tamol™ 165, a wetting agent such as BYK® 348, a biocide such as Nuosept® 95, a defoamer such as BYK® 024, an anticorrosive pigment such as Halox® 430.

Example 1 of TABLE 6. The corresponding average oil absorption was 30.05. The gravity density was 2.96. The safe PVC for non blocking was 62% for polymers with a Tg at 50° C. Wet picking to determine wet adhesion was 55% after application to a fiber cement building material.

Example 2 of TABLE 6. Due to easy setting of SiO₂ and CaSiO₃ these components were omitted. For non blocking, a PVC of 66% for polymers was provided with Tg at 50° C. Wet picking of adhesion was less than 10% after application to a fiber cement building material. Salt water absorption was about 26% after 8 hours of soaking when applied to a fiber cement building specimen.

Example 3 of TABLE 6. Zinc stearate was added to Example 2 to prepare this formulation. The safe PVC for non blocking was 66% for polymers with Tg at 50° C. Wet picking was less than 10% when applied to a fiber cement building material. The salt water absorption was 13% after 8 hrs of soaking (as compared with 26% for Example 2, which lacked zinc stearate).

Example 4 of TABLE 6. An ion scavenger (Halox® 430) and anticorrosive pigment (ZMP) were added to the recipe of Example 3. The salt water absorption was reduced to about 10%. Wet picking was 50% for safe non blocking PVC of 66% for polymers with Tg at 50° C.

Example 5 of TABLE 6. To a recipe of Example 3, NeoCryl® A639 (trademark of DSM IP Assets B.V., The Netherlands) was used as the binder. It had a Tg at 62° C. and MFT at 53° C. PVC was from 10 to 80% for non blocking performance. A preferred PVC was between about 10% to 65% for both a non blocking and wet picking of zero.

When coating a composite building material with a primer formulation described herein, the coating may be applied by methods known in the art, including brushing, spraying, dabbing, and all forms in between The primer formulation may be applied to a cured or uncured composite building material that is sealed or unsealed. The primer formulation may be applied to all or a portion of the exposed surface of the composite building material. In one representative example, the primer formulation is applied to unsealed fiber cement building materials. In a first embodiment, the fiber cement building materials were uncured. In a second embodiment, the fiber cement building materials were at least partially cured. The primer formulation was applied at a thickness less than 1 mil, preferably less than 0.8 mil, preferably between about 0.25 mil and 0.6 mil. Relative thickness will depend on the material and its use. The thickness may be achieved in a single coat or may be reached by additional consecutive coats. After application of the primer formulation to the desired thickness, the fiber cement building material is cured. Curing is preferably in oven an oven with an exit board surface temperature of at or about 150 degrees Fahrenheit or greater. As such, described herein is a composite building material coated with at least one layer of a primer formulation as evidenced in TABLES 5-6, in which the composite building material may be cured or uncured, sealed or unsealed, and the primer formulation as described herein is applied to a thickness of 1.0 mil or less, wherein the coated composite building material is then cured.

Embodiments of the primer described herein provided certain improved physical and chemical properties as compared with an alternative primer. In some embodiments, a primer has improved moisture absorption characteristics. In a preferred implementation, a primer formulation as described herein when provided to a composite building material promotes a reduction in moisture absorption of about 25%, more preferably about 50%, more preferably about 75% as compared to an equivalent coating of a different primer.

A primer as described herein also provides a composite building material with improved adhesion to paint and other exterior coatings such that the peel failure is reduced from about a 70%-90% failure rate to better than about 50%, more preferably better than about 25%, more preferably better than a near 0% failure rate.

While primers for composite building materials, such as cementitious materials, are available, alternate, conventional primers are not adequate and have poor performance with composite building materials (e.g., materials that are generally cementitious, gypsum, or of another inorganic building material, such as those containing cellulose, glass, steel or polymeric fibers). Additionally, some alternate, conventional primers typically have a high viscosity, form a film on the surface of the building material and do not effectively block moisture from penetrating the composite building material. Consequently, paint adhesion and long term paint durability on these composites are less than optimal. As described herein is a primer that overcomes these and other problems when applied to a composite building material and acts as a weather-guard or hydrophobic treatment to all surfaces of the composite building material.

Also described is a method of forming at least one layer of a primer formulation on an article comprising the steps of applying a first layer to a substrate, the first layer comprising a primer formulation, and applying a second layer on the first, wherein the second layer is a topcoat.

In still additional embodiments, a primer disclosed herein, when applied to a composite building material, improves adhesion between the composite material and a sealer and/or paint.

Embodiments described herein advantageously provide composite building materials with one or more desirable characteristics, such as reduced water absorption, reduced rate of water absorption, lower water migration, and lower water permeability, enhanced wet and dry adhesion, improved stack damage resistance, improved freeze-thaw resistance (e.g., in water or in solutions comprising a soluble salt), chemical resistance, resistance to soluble salt ingress, and better mechanical properties as compared to materials absent embodiments described herein or as compared with building materials comprising alternative or conventional primers.

In addition, described herein is application of a primer formulation described to a composite building material, wherein application includes coating a primer formulation to a composite building material, such as a fiber cement material, to a thickness of 1.0 mil or less, wherein the composite building material is uncured or partially cured and then cured after coating. Curing preferably includes baking at a temperature greater than 150° or 160° F. until the coated composite has surface temperature greater than 150° or 160° F.

Still further, described herein is an improved primer formulation for the improved adhesion of a topcoat to a composite building materials, wherein the improvement is a reduction in a peel failure of the topcoat by greater than 50% as compared to a primer of a same thickness and a different formulation.

An improved primer formulation for the improved performance of a composite building materials is also described herein, wherein the improvement is a reduction in moisture absorption of about 25% as compared to a primer of a same thickness and a different formulation.

A composite building material with an improved primer formulation applied to its surface is described herein, wherein the improved primer formulation reduces moisture absorption of the composite building material by at least 25% as compared to a primer formulation of a same thickness and a different formulation.

In a process for priming a fiber cement building product, the process may comprise the step of coating a fiber cement building product with an improved primer formulation as described herein.

Although the foregoing description of the preferred embodiments has shown, described and pointed out certain novel features of the invention, it will be understood that various omissions, substitutions, and changes in the form of the detail as illustrated as well as the uses thereof, may be made by those skilled in the art, without departing from the scope of the invention. Particularly, it will be appreciated that the preferred embodiments may manifest itself in other shapes and configurations as appropriate for the end use of the article made thereby.

What is claimed is:

1. A primer formulation for composite building materials comprising a polymer, wherein the polymer has a glass transition temperature of about 50° to 70° C. and a minimum film formation temperature of at or below about 30° C.

2. A primer formulation for composite building materials comprising:
at least one hard polymer, wherein the hard polymer has a glass transition temperature of at or below about 30° C.; and
at least one soft polymer, wherein the soft polymer has a glass transition temperature of greater than 50° C.

3. A primer formulation for composite building materials comprising one or more polymers, wherein the polymer has a particle size distribution that is bimodal.

4. The formulation of claim 3, wherein the particle size distribution includes a first peak at or below about 100 nanometers and a second peak greater than about 200 nanometers.

5. A primer formulation for composite building materials comprising:
up to 60% water;
up to 1% of one or more dispersants;
up to 0.5% of one or more wetting agents;
up to 1% of one or more biocides;
up to 1% of one or more antiblocking agents;
up to 0.5% of one or more thickeners;
up to 1% of one or more pH adjusters;
up to 50% of one or more acrylate polymers;
up to 30% of one or more pigments;
up to 70% of one or more extenders;
up to 30% of one or more fillers, and
up to 1% of one or more functional pigments.

6. The formulation of claim 1, wherein at least one of the one or more dispersants is a hydrophobic copolymer polyelectrolyte.

7. The formulation of claim 1, wherein at least one of the one or more wetting agents is an acrylic wetting agent.

8. The formulation of claim 1, wherein at least one of the one or more biocides is an industrial alginate.

9. The formulation of claim 1, wherein at least one of the one or more thickeners is a non-ionic urethane.

10. The formulation of claim 1, wherein at least one of the one or more self cross-linking polymers is latex.

11. The formulation of claim 1, wherein at least one of the one or more pigments is titanium oxide, iron oxide, phthalocyanine blue and any combination thereof.

12. The formulation of claim 1, wherein at least one of the one or more extenders is selected from the group consisting of calcium carbonate, talc, calcined clay, calcium silicate and any combination thereof.

13. The formulation of claim 1, wherein the formulation improves adhesion of a topcoat to the composite building material.

14. An improved primer formulation for improved adhesion of a topcoat to a composite building material, wherein the improvement is a reduction in a peel failure of the topcoat by greater than 50% as compared to a primer of a same thickness and a different formulation.

15. An improved primer formulation for improved performance of a composite building material, wherein the improvement is a reduction in moisture absorption of about 25% as compared to a primer of a same thickness and a different formulation.

16. A composite building material with an improved primer formulation applied to its surface, wherein the improved primer formulation reduces moisture absorption of the composite building material by at least 25% as compared to a primer formulation of a same thickness and a different formulation.
